(19) United States
(12) Patent Application Publication
(10) Pub. No.: US 2026/0191241 A1
(43) Pub. Date: Jul. 9, 2026

(54) HEAT AND HUMIDITY RESISTANT AGGREGATE FOOD PRODUCT

(71) Applicant: GENERAL MILLS, INC., Minneapolis, MN (US)

(72) Inventors: Jeffrey F. ENZ, Minneapolis, MN (US); Karolina CADELSKA-MAJEWSKA

(73) Assignee: GENERAL MILLS, INC., Minneapolis, MN (US)

(21) Appl. No.: 19/133,452

(22) PCT Filed: Dec. 20, 2022
(86) PCT No.: PCT/US2022/082019

§ 371 Date: May 28, 2025

(51) Int. Cl. A23L 7/126; A23G 3/36; A23L 29/10; A23L 29/231; A23L 29/281; A23L 29/30

(52) U.S. Cl. CPC A23L 7/126; A23G 3/36; A23L 29/10; A23L 29/231; A23L 29/284; A23L 29/37

(57) ABSTRACT

Packaged food products are described that include an aggregate composition that is stable in tropical conditions for an extended shelf life. The aggregate includes a pliable binder that comprises pectin and/or gelatin. A pliable binder in a packaged food product remains chewy and continues to bind water permeable particulates over shelf life in tropical conditions. Also described are methods of making a packaged food product.

### BACKGROUND

Consumers enjoy convenient snack foods that provide a variety of eating experiences. Convenient, shelf stable snack foods are available in various forms, such as snack mixes and snack bars. Shelf stable snack foods provide a number of benefits to consumers. They are generally ready-made without requiring refrigeration or preparation; they can often be consumed without needing utensils; and they provide a variety of flavors and textures to satisfy a wide array of cravings. However, in tropical regions, heat and humidity can affect the texture of shelf stable foods such as cereal bars, limiting the number of options for consumers that live in such regions. Thus, there is a need for snack food formulations that can retain a desirable texture over shelf life in tropical regions.

### SUMMARY

The present disclosure relates to a shelf stable, ready-to-eat aggregate snack that is resistant to changes in texture over a shelf life in hot and humid conditions.

A packaged food product is provided herein. The packaged food product is stable at a temperature of 21° C. and 65% humidity over a shelf life of at least 8 months, and includes an aggregate composition having a water activity of about 0.2 to about 0.7 and including a. water permeable particulates in an amount of from about 35% to about 75% by weight of the aggregate composition, the particulates having at least a portion of a surface coated with a crystalline coating; and b. a pliable binder in an amount of about 25% to about 50% by weight of the aggregate composition, where the binder binds the particulates together. The binder includes pectin in an amount of about 0.5% to about 1.2% by dry weight of the binder, or gelatin in an amount of about 0.5% to about 4% by dry weight of the binder; a humectant component; fat in an amount of about 10% to about 18% by dry weight of the binder; and emulsifier in an amount of from about 0.1% to about 1% by dry weight of the binder. A humectant component includes a carbohydrate syrup contributing carbohydrate in an amount of about 35% to about 50% by dry weight of the binder; and a short chain polyol in an amount of about 14% to about 25% by dry weight of the binder.

In some embodiments, the binder can have a total fat content of less than 16% by dry weight of the binder. In some embodiments, the binder can include pectin in an amount of about 0.6% to about 1.0% by dry weight of the binder. In come embodiments, the binder can include a bulking component in an amount of up to 35% by dry weight of the binder. In some embodiments, the bulking component can include a dairy powder, cocoa powder, a calcium ingredient, a fiber, or a sugar.

In some embodiments, the short chain polyol can include glycerol in an amount of about 8% to about 18% by dry weight of the binder and sorbitol in an amount of about 4% to about 12% by dry weight of the binder.

In some embodiments, the food product can have a water activity of about 0.25 to about 0.45.

In some embodiments, the water permeable particulates can have a crystalline coating.

In some embodiment, the aggregate composition can have inclusions.

A method of making a packaged food product that is stable at temperatures of at a temperature of 21° C. and 65% humidity over a shelf life of at least 8 months is also provided. The method includes combining binder ingredients to make an emulsion; heating the emulsion to a temperature and for a time sufficient to hydrate the pectin or the gelatin and to reduce the moisture content of the emulsion to about 7% by weight to produce a binder; combining the binder with water permeable particulates to form an aggregate composition, wherein the binder binds the particulates together, the aggregate composition comprising the permeable particulates in an amount of about 35% to about 75% by weight of the aggregate composition and the binder in an amount of about 25% to about 50% by weight of the aggregate composition; and forming the aggregate composition into pieces. The emulsion includes pectin in an amount of about 0.5% to about 1.2% by dry weight of the emulsion, or gelatin in an amount of about 0.5% to about 4% by dry weight of the emulsion; a humectant component; fat in an amount of about 10% to about 18% by dry weight of the emulsion; and emulsifier in an amount of from about 0.1% to about 1% by dry weight of the emulsion; where the humectant component includes a carbohydrate syrup contributing carbohydrate in an amount of about 35% to about 50% by dry weight of the emulsion; and a short chain polyol in an amount of about 14% to about 25% by weight of the emulsion;

In some embodiments, the temperature can be at least 80° C. or at least 90° C. In some embodiments, the temperature can be 80° C. to 110° C. In some embodiments, the temperature can be 90° C. to 110° C.

In some embodiments, the water permeable particulates can have a crystalline coating.

These and various other features and advantages will be apparent from a reading of the following detailed description.

### DETAILED DESCRIPTION

Some shelf stable snack bars include aggregates of crispy and/or crunchy particulates, such as puffed breakfast cereal pieces, bound together with a pliable binder that provides a dual chewy and crunchy texture enjoyed by consumers. These snack bars are generally stable in form and retaining a quality eating experience over an extended shelf life at 20-22° C. and a relative humidity of less than 50%. However, such snack bars are prone to becoming fragile, with the binder failing to hold particulates together, with prolonged exposure to tropical conditions (e.g., 21-45° C. and 65-75% relative humidity), even in moisture-resistant packaging. This is particularly problematic in regions where it is not common to control the temperature or humidity in retail stores.

A unique shelf stable, packaged food product is described herein. It was discovered, and is disclosed herein, that a packaged food product that includes a dual texture chewy and crunchy aggregate of water permeable particulates (e.g., puffed breakfast cereal pieces, rolled grain, cookie crumbs, and the like) bound together by a flexible binder containing pectin and/or gelatin can remain stable over an extended shelf life in tropical conditions. Surprisingly, a packaged food product including such an aggregate remains stable for at least 8 months (e.g., at least 10 months, or about 12 months to about 15 months) of shelf life in tropical conditions, including at a temperature of 21° C. and 65% humidity. More surprisingly, in some embodiments, a disclosed packaged food product can even remain stable for a shelf life of at least 8 months (e.g., at least 10 months, or about 12 months to about 15 months) of shelf life at a temperature of 45° C. and 75% humidity. As used herein, the term “stable” refers to a packaged food product that exhibits substantially the same form (e.g., holds together) and retains a quality eating experience (e.g., flavor and texture) over shelf life.

A packaged food product generally includes an aggregate of particulates (about 35% to about 75%, or about 45% to 65% by weight of the aggregate) bound together by a pliable binder (about 25% to about 50%, or about 35% to about 50% by weight of the aggregate). A packaged food product typically has a water activity of up to about 0.7 (e.g., about 0.2 to about 0.7, about 0.25 to about 0.6, or about 0.25 to about 0.45), and has a shelf life of at least 8 months (e.g., at least 10 months, at least 12 months, or about 12 months to about 15 months) in a package in tropical conditions.

A pliable binder included in a packaged food product provided herein includes pectin and/or gelatin, a humectant component that includes a carbohydrate syrup and a short chain polyol, fat, and emulsifier in amounts that enable the pliable binder to provide a chewy texture to an aggregate and remain chewy over shelf life without falling apart when exposed to tropical conditions over shelf life. In comparison, a packaged food product including a pliable binder that contains the same components in the same ratios, but excluding pectin and/or gelatin, can be used to produce an aggregate that is stable at 20-22° C. and less than 50% humidity, but falls apart in tropical conditions. In addition, a pliable binder provided herein, including pectin and/or gelatin, enables a lower amount of binder to be used to achieve sufficient binding of particulates. This provides a benefit of minimizing the amount of water introduced into an aggregate that includes water permeable particulates, reducing the impact of water in the binder in addition to atmospheric humidity on the water permeable particulates so that they do not become too soggy and/or stale over shelf life. In the case of crunchy particulates, they can remain crunchy longer, extending shelf life.

A pliable binder includes pectin in an amount of about 0.5% to about 1.2% (e.g., about 0.6% to about 1%) by dry weight of the pliable binder and/or gelatin in an amount of about 0.5% to about 4% (e.g., about 1% to about 3%) by dry weight of the pliable binder. Pectin and/or gelatin included in a pliable binder contributes to the ability of the binder to hold particulates together when exposed to tropical conditions. Any pectin can be suitably used in a pliable binder. In some embodiments, a suitable pectin can be a low ester pectin and/or a high calcium-reactive pectin. Similarly, any gelatin can be suitably used in a pliable binder.

A pliable binder includes a humectant component, including a carbohydrate syrup and a short chain polyol. A carbohydrate syrup in a pliable binder contributes carbohydrate in an amount of about 35% to about 50% (e.g., about 40% to about 48%) by dry weight of the pliable binder. Suitable carbohydrate syrups typically include at least some non-sucrose sugar, and include without limitation, glucose syrup, invert syrup, honey, malt, molasses, and the like, or any combination thereof. Particularly useful carbohydrate syrups include glucose syrup and/or invert syrup. Carbohydrate syrup included in a pliable binder contributes to the ability of the binder to remain pliable over shelf life without interfering with binding of particulates together. Although a carbohydrate syrup can contain sucrose, preferably the amount of crystalline sucrose in a pliable binder is preferably limited because sucrose can contribute to hardening of the binder. In some embodiments, crystalline sucrose can be included in an amount of less than 25% (e.g., less than 20%, or less than 10%) by dry weight.

A humectant component in a pliable binder includes a short chain polyol, such as glycerol and/or sorbitol, in an amount of about 14% to about 25% (e.g., about 17% to about 22%) by weight of the binder. In some embodiments, a pliable binder can contain glycerol in an amount of about 8% to about 18% (e.g., about 10% to about 15%) by dry weight of the binder and sorbitol in an amount of about 4% to about 10% (e.g., about 5% to about 8%) by dry weight of the binder. A short chain polyol included in a pliable binder contributes to the ability of the binder to remain pliable over shelf life without contributing to an oily texture. In addition, a short chain polyol can help contribute to a mouthfeel that is perceived as moist while keeping a water activity within the desired range.

A pliable binder includes fat in an amount of about 10% to about 18% (e.g., about 12% to about 16%) by dry weight of the pliable binder. Fat included in a pliable binder contributes to the ability of the binder to remain pliable over shelf life without interfering with binding of particulates together. Fat in a pliable binder may also contribute to preventing particulates from becoming soggy over shelf life. An amount of fat exceeding 18% by weight of a pliable binder may result in an aggregate in a shelf stable food that is too loose and more likely to break or pull apart during shelf life. Any edible fat can be used in a pliable binder, such as canola/rapeseed oil, soybean oil, sunflower oil, palm oil, coconut oil, fractions of any edible oil, and the like, or any non-interesterified or interesterified combination thereof. In some embodiments, other ingredients, such as cocoa powder, can contribute fat content to a pliable binder. In some embodiments, fat content of a pliable binder is less than 16% by dry weight.

A pliable binder contains an emulsifier in an amount of about 0.1% to about 1% (e.g., about 0.2% to about 0.7%) by dry weight of the pliable binder. An emulsifier aids in processing while manufacturing a shelf stable food provided herein by ensuring that the pectin and/or gelatin, the humectant component, and the fat are homogenously mixed. In some cases, an emulsifier can reduce oil separation from an aggregate over shelf life.

In some embodiments, a pliable binder can include a bulking component in an amount of up to 35% (e.g., up to 30%, up to 25%, or about 15% to 25%) by dry weight of the binder. A bulking component can include, for example, dairy powder (e.g., milk powder, whey powder, and the like), a calcium ingredient (e.g., calcium carbonate), fiber (e.g., fructooligosaccharide, maltodextrin, polydextrose, inulin, and the like), sugar (e.g., sucrose in limited amounts, glucose, fructose, fruit powder, and the like), and the like, or any combination thereof. A bulking component can contribute to desired taste and/or texture attributes to a pliable binder. In addition, a bulking component can aid in processing during manufacturing by contributing to viscosity of a pliable binder which can aid in handling of the binder and aid in distribution of the binder in an aggregate. In some embodiments, a bulking component can be selected based on a preferred nutritional profile. For example, a bulking component can be selected to provide one or more bulking component benefit while contributing little or no sugar and/or few or no calories.

In some embodiments, a pliable binder can include other ingredients in minor amounts, such as flavorants (e.g., vanilla, cinnamon, salt, and the like), colorants, vitamins, minerals, preservatives (e.g., tocopherols, citric acid, and the like), high intensity sweetener (e.g., stevia extract or monk fruit extract), and the like, or any combination thereof. Other ingredients are typically included in a total amount of up to about 5% (e.g., up to 3%, or up to 2%) by dry weight of the pliable binder.

A pliable binder provided herein typically has a moisture content of about 5% to less than 9% (e.g., about 6% to about 8%, or about 7%). Moisture content in a pliable binder can be contributed by the inclusion of water as an ingredient and/or water content in any of the other included ingredients. Such a moisture content can contribute to a water activity within the desired range, and chewiness over shelf life without resulting in sogginess of particulates within an aggregate. In addition, a moisture content of from about 5% to less than 9% can enable a pliable binder to be used in an aggregate without requiring drying and/or baking to achieve effective binding. It was also discovered that a pliable binder that had a moisture content of 9% or higher was prone to dissolving over a shelf life in tropical conditions, while a moisture content of less than 5% was more difficult to process during manufacturing due to high viscosity.

Particulates suitable for combining with a pliable binder to produce an aggregate include any shelf-stable, water permeable edible particulates, such as puffed breakfast cereal pieces, rolled grains, puffed grains, puffed protein bits, and the like, or any combination thereof. Advantageously, an aggregate that includes a pliable binder described not only contains particulates that readily absorb water without becoming soggy over shelf life, but such water permeable particulates absorb some of the pliable binder to enhance binding of the particulates together. As such, crispy and crunchy particulates can provide a pleasing contrast to a chewy texture contributed by a pliable binder over shelf life. In some embodiments, water particulates can include a crystalline coating on at least a portion of a surface of the particulates. For example, water permeable particulates can have a sucrose, maltitol, and/or erythritol-based coating on at least a portion of the surface of the particulates. A crystalline coating can limit the amount of pliable binder absorbed by water permeable particulates to prevent sogginess as a result of absorbing too much of the binder, and can reduce absorption of atmospheric moisture to reduce the risk of becoming soggy and/or stale over shelf life in tropical conditions.

In some embodiments, an aggregate can also contain inclusions that are less water permeable than the above-described particulates. Suitable inclusions can include, without limitation, nuts, confections, fat-based pieces (e.g., compound and/or chocolate chips), and the like or any combination thereof.

Methods of making a packaged food product are also provided herein. Generally, a method includes combining binder ingredients to make an emulsion, heating the emulsion to a temperature and for a time sufficient to hydrate pectin and/or gelatin in the emulsion and to reduce the moisture content of the emulsion to form a pliable binder as described above, combining the pliable binder with water permeable particulates to form an aggregate composition that has about 35% to about 75% by weight particulates and about 25% to about 50% by weight pliable binder, and forming the aggregate composition into pieces. In some embodiments, an emulsion is heated to a temperature of at least 80° C. (e.g., 80° C. to 110° C.). Preferably, the emulsion reaches at least 90° C. to reduce risk of microbial growth during shelf life. At temperatures exceeding 110° C., a pliable binder may experience changes in flavor, while at temperatures below 80° C., a fluid binder may not provide effective binding.

An aggregate can be packaged alone or in combination with one or more additional food ingredients, such a coating, drizzle, and/or particulates applied to a surface of the aggregate. Generally, ingredients applied to the surface of an aggregate should be resistant to tropical conditions to prevent sogginess, stale flavor, and/or melting of the surface ingredients. A shelf stable food product can be packaged in any appropriate packaging material, such as a plastic, foil, or paper-based wrapper.

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A packaged food product, the packaged food product being stable at a temperature of 21° C and 65% humidity over a shelf life of at least 8 months and comprising an aggregate composition, the aggregate composition having a water activity of about 0.2 to about 0.7 and including:
a. water permeable particulates in an amount of from about 35% to about 75% by weight of the aggregate composition; and
b. a pliable binder in an amount of about 25% to about 50% by weight of the aggregate composition, the binder binding the particulates together, and comprising:
i. pectin in an amount of about 0.5% to about 1.2% by dry weight of the binder, or gelatin in an amount of about 0.5% to about 4% by dry weight of the binder;
ii. a humectant component, including:
1) a carbohydrate syrup contributing carbohydrate in an amount of about 35% to about 50% by dry weight of the binder; and
2) a short chain polyol in an amount of about 14% to about 25% by dry weight of the binder;
iii. fat in an amount of about 10% to about 18% by dry weight of the binder; and
iv. emulsifier in an amount of from about 0.1% to about 1% by dry weight of the binder.

2. The packaged food product of claim 1, wherein the binder has a total fat content of less than 16% by dry weight of the binder.

3. The packaged food product of claim 1, wherein the binder comprises pectin in an amount of about 0.6% to about 1.0% by dry weight of the binder.

4. The packaged food product of any of claim 1, wherein the food product has a water activity of about 0.25 to about 0.45.

5. The packaged food product of any of claim 1, wherein the water permeable particulates have a crystalline coating.

6. The packaged food product of any of claim 1, wherein the binder comprises a bulking component in an amount of up to 35% by dry weight of the binder.

7. The packaged food product of claim 6, wherein the bulking component comprises a dairy powder, cocoa powder, a calcium ingredient, a fiber, or a sugar.

8. The packaged food product of claim 1, wherein the short chain polyol comprises glycerol in an amount of about 8% to about 18% by dry weight of the binder and sorbitol in an amount of about 4% to about 12% by dry weight of the binder.

9. The packaged food product of claim 1, wherein the aggregate composition comprises inclusions.

10. A method of making a packaged food product, the packaged food product being stable at temperatures of at a temperature of 21° C. and 65% humidity over a shelf life of at least 8 months, the method comprising:
a. combining binder ingredients to make an emulsion, the binder ingredients including:
i. pectin in an amount of about 0.5% to about 1.2% by dry weight of the emulsion, or gelatin in an amount of about 0.5% to about 4% by dry weight of the emulsion;
ii. a humectant component, including:
1. a carbohydrate syrup contributing carbohydrate in an amount of about 35% to about 50% by dry weight of the emulsion; and
2. a short chain polyol in an amount of about 14% to about 25% by dry weight of the emulsion;
iii. fat in an amount of about 10% to about 18% by dry weight of the emulsion; and
iv. emulsifier in an amount of from about 0.1% to about 1% by dry weight of the emulsion;
b. heating the emulsion to a temperature and for a time sufficient to hydrate the pectin or the gelatin and to reduce the moisture content of the emulsion to about 7% by weight to produce a binder;
c. combining the binder with water permeable particulates to form an aggregate composition, wherein the binder binds the particulates together, the aggregate composition comprising the permeable particulates in an amount of about 35% to about 75% by weight of the aggregate composition and the binder in an amount of about 25% to about 50% by weight of the aggregate composition; and
d. forming the aggregate composition into pieces.

11. The method of claim 10, wherein the temperature is at least 80° C.

12. The method of claim 10 wherein the water permeable particulates have a crystalline coating.
